(19) United States
(12) Patent Application Publication
(10) Pub. No.: US 2015/0121180 A1
(43) Pub. Date: Apr. 30, 2015

(54) Systems and Methods for Presentation Version Management

(71) Applicant: Promethean Limited, Blackburn (GB)

(72) Inventors: Steve S. Benfield, Atlanta, GA (US); Sriraman Venkataraman, Norcross, GA (US)

(73) Assignee: PROMETHEAN LIMITED, Blackburn (GB)

(21) Appl. No.: 14/065,034

(22) Filed: Oct. 28, 2013

(51) Int. Cl. G06F 17/24

(52) U.S. Cl. CPC G06F 17/24
USPC 715/202

(57) ABSTRACT

A computer system for managing presentation modification is configured to enable one or more users to request association of an author-created presentation with an account associated with the one or more users. In various embodiments, the system is configured to enable the author to make one or more modifications to the presentation. At least partially in response to modification by the presentation by the author, the system is configured to enable the one or more users to incorporate the one or more medications to the presentation associated with their account. In particular embodiments, the system is configured to store, in memory, each version of the presentation with various modifications and enable the one or more users to select any version of the presentation for presentation to at least one presentation viewer.

### BACKGROUND

Presentation systems generally enable a presenter to create and display (e.g., present) a series of pre-set (e.g., static) slides to one or more viewers or participants during a presentation. While such presentation systems may be useful, the presenter may desire a more dynamic way to display the presentation, to create and share presentations, and to modify and update presentations.

Various embodiments of the present systems and methods recognize and address the foregoing considerations, and others, of prior art systems and methods.

### SUMMARY

A computer system, according to various embodiments, comprises at least one processor. In particular embodiments, the computer system is configured for: (a) enabling an author to create a presentation, the presentation comprising at least one slide; (b) associating the presentation with an account of the author; (c) receiving a request from a presenter to associate the presentation with an account of the presenter; (d) at least partially in response to receiving the request to associate the presentation with the account of the presenter, associating a copy of the presentation with the account of the presenter; (e) facilitating at least one modification to the presentation by the author; and (f) at least partially in response to facilitating the at least one modification to the presentation by the author, facilitating including the at least one modification to the copy of the presentation associated with the presenter's account.

A computer-implemented method, according to particular embodiments, comprises receiving, by a processor, from one or more authors, a first presentation comprising one or more slides, each of the one or more slides comprising one or more objects. In various embodiments, the method further comprises receiving, by a processor, from one or more users, a request to associate the first presentation with one or more accounts associated with the one or more users. In particular embodiments, the method further comprises at least partially in response to receiving the request, associating, by a processor, a second presentation with the one or more accounts, the second presentation being identical to the first presentation. The method, in various embodiments, further comprises receiving, by a processor, an indication that the one or more authors have made one or more modifications to the first presentation. In particular embodiments, the method comprises at least partially in response to receiving the indication, enabling, by a processor, the one or more users to selectively incorporate the one or more modifications into the second presentation.

A non-transitory computer-readable medium, in various embodiments, stores computer-executable instructions for: (a) enabling an author to create a first version of a presentation; (b) receiving a first request from one or more users to associate the first version of the presentation with one or more accounts associated with the one or more users; (c) at least partially in response to receiving the first request, associating the first version of the presentation with the one or more accounts; (d) receiving an indication of one or more modifications to the first version of the presentation by the author; (e) notifying the one or more users of the one or more modifications; and (f) receiving, from the one or more users, a second request to associate a second version of the presentation with the one or more accounts, the second version of the presentation comprising one or more of the one or more modifications.

### BRIEF DESCRIPTION OF THE DRAWINGS

Various embodiments of a system and method for managing versions of a presentation are described below. In the course of this description, reference will be made to the accompanying drawings, which are not necessarily drawn to scale, and wherein:

FIG. 1 is a block diagram of an exemplary presentation system in accordance with an embodiment of the present system;

FIG. 2 is a schematic diagram of a computer, such as the computing device of FIG. 1, that is suitable for use in various embodiments;

FIG. 3 depicts a flowchart that generally illustrates various steps executed by a Presentation Modification Module that, for example, may be executed by the computing device of FIG. 1;

FIG. 4 shows a screen display of various features of the presentation system according to various embodiments.

### DETAILED DESCRIPTION

Various embodiments now will be described more fully hereinafter with reference to the accompanying drawings. It should be understood that the invention may be embodied in many different forms and should not be construed as limited to the embodiments set forth herein. Like numbers refer to like elements throughout.

### Overview

A system for managing modifications to presentations, according to various embodiments, is configured to enable one or more authors to provide a presentation that the one or more authors have created to one or more users. In various embodiments, the presentation comprises one or more slides that comprise one or more objects. In some embodiments, the one or more objects include one or more images, one or more videos, one or more text objects, one or more web pages, one or more interactive games or activities, etc. In particular embodiments, the system is configured to enable the one or more users to associate a desired presentation with one or more accounts of the one or more users. For example, in various embodiments, an author generates the presentation and places the presentation in a marketplace for others to purchase or use. One or more users may find the presentation in the market place and subscribe to use the presentation. In particular embodiments, when the one or more users subscribe to a presentation, the system is configured to associate a copy of the presentation with the one or more user's account. In various embodiments, the system is further configured to enable the one or more users to access the presentation via the one or more accounts (e.g., in order to review the presentation, present the presentation, etc.).

In particular embodiments, the system is configured to enable the one or more authors to modify the presentation. At least partially in response to one or more modifications to the presentation by the one or more authors, the system may be configured to enable the one or more users to selectively incorporate the one or more modifications into the version of the presentation associated with their respective one or more accounts. In particular embodiments, the system is configured to store in memory one or more copies of various versions of a particular presentation (e.g., versions of a presentation which may differ based on the selective incorporation of the one or more modifications by the one or more users).

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

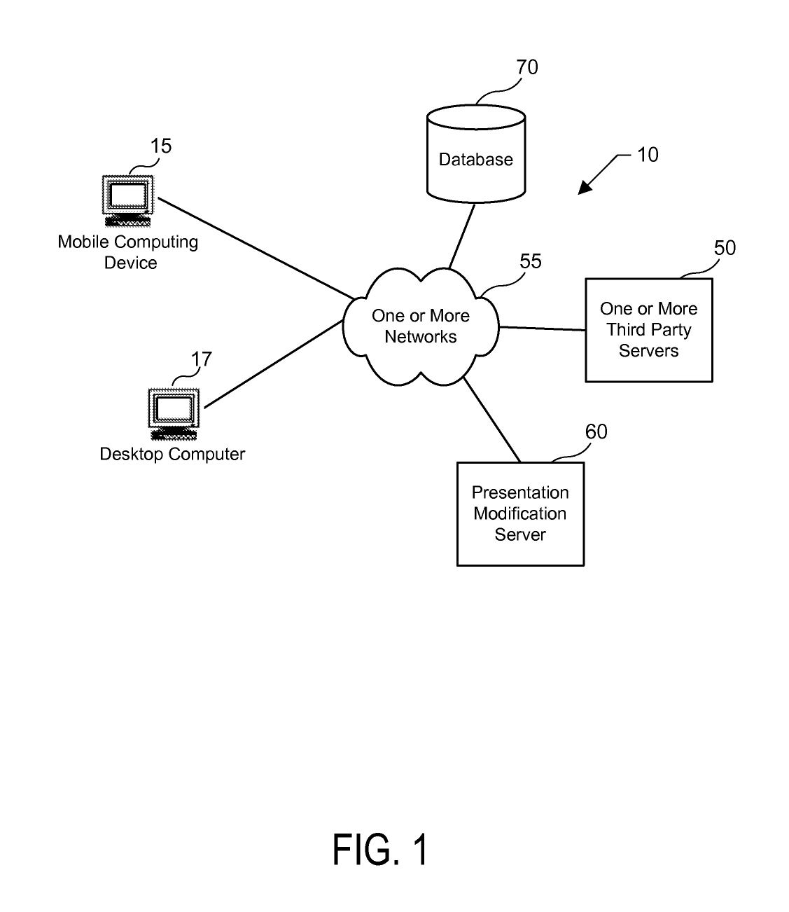

FIG. 1 is a block diagram of a presentation modification system 10 according to a particular embodiment. As may be understood from this figure, the system 10 includes one or more computer networks 55, one or more third party servers 50, a presentation modification server 60, a database 70, and one or more remote computing devices as indicated by mobile computing device 15 (e.g., a smart phone, a tablet computer, a wearable computing device, a laptop computer, etc.) or a desktop computer 17. In particular embodiments, the one or more computer networks facilitate communication between the one or more third party servers 50, the presentation modification server 60, the database 70, and the one or more remote computing devices 15, 17.

The one or more computer networks 55 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers). The communication link between the one or more third party servers 50, the presentation modification server 60, and the database 70 may be, for example, implemented via a Local Area Network (LAN) or via the Internet.

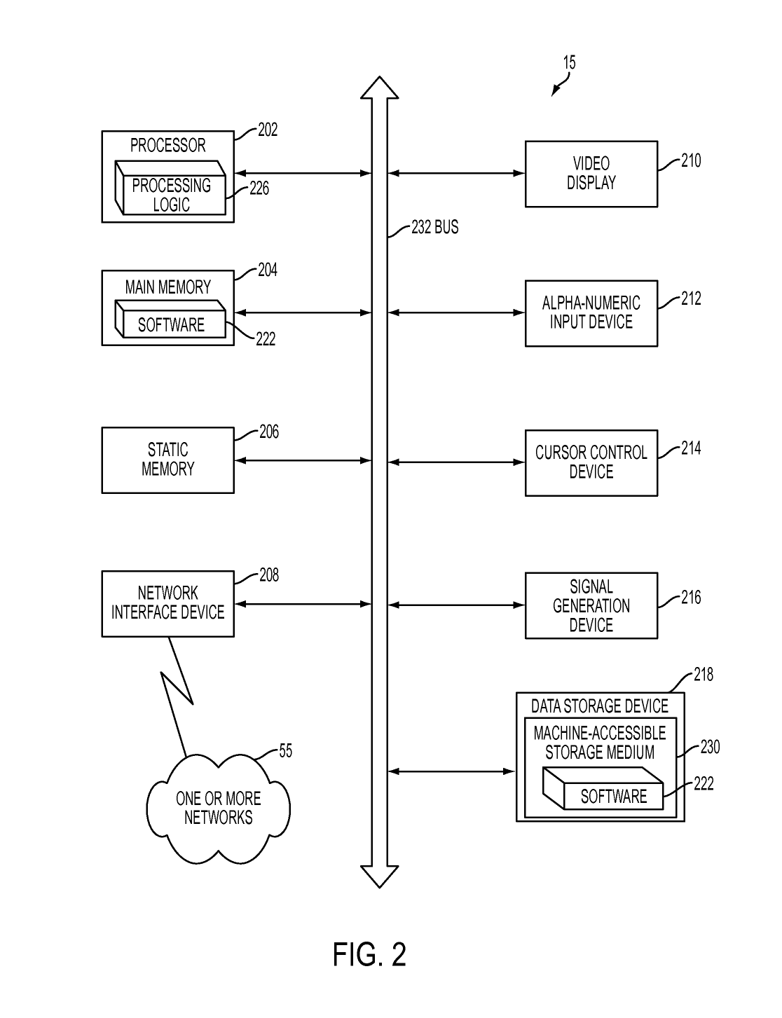

FIG. 2 illustrates a diagrammatic representation of a computer architecture 15 that can be used within the system 10, for example, as a client computer (e.g., one of client computers 15, 17 shown in FIG. 1), or as a server computer (e.g., presentation modification server 60 shown in FIG. 1). In particular embodiments, the computer 15 may be suitable for use as a computer within the context of the system 10 that is configured for managing presentation modification.

In particular embodiments, the computer 15 may be connected (e.g., networked) to other computers in a LAN, an intranet, an extranet, and/or the Internet. As noted above, the computer 15 may operate in the capacity of a server or a client computer in a client-server network environment, or as a peer computer in a peer-to-peer (or distributed) network environment. The computer 15 may be a desktop personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 15 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose or specific processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 15 may further include a network interface device 208. The computer 15 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions (e.g., software 222) embodying any one or more of the methodologies or functions described herein. The software 222 may also reside, completely or at least partially, within the main memory 204 and/or within the processing device 202 during execution thereof by the computer 15—the main memory 204 and the processing device 202 also constituting computer-accessible storage media. The software 222 may further be transmitted or received over a network 55 via a network interface device 208.

While the computer-accessible storage medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium that is capable of storing, encoding or carrying a set of instructions for execution by the computer and that cause the computer to perform any one or more of the methodologies of the present invention. The term “computer-accessible storage medium” should accordingly be understood to include, but not be limited to, solid-state memories, optical and magnetic media, etc.

### Exemplary System Platform

Various embodiments of a system for managing modifications to presentations may be implemented in any suitable context. For example, particular embodiments may be implemented within the context of any suitable presentation creation and/or modification system. Various aspects of the system's functionality may be executed by certain system modules, including a Presentation Modification Module 300. This module is discussed in greater detail below.

### Presentation Modification Module

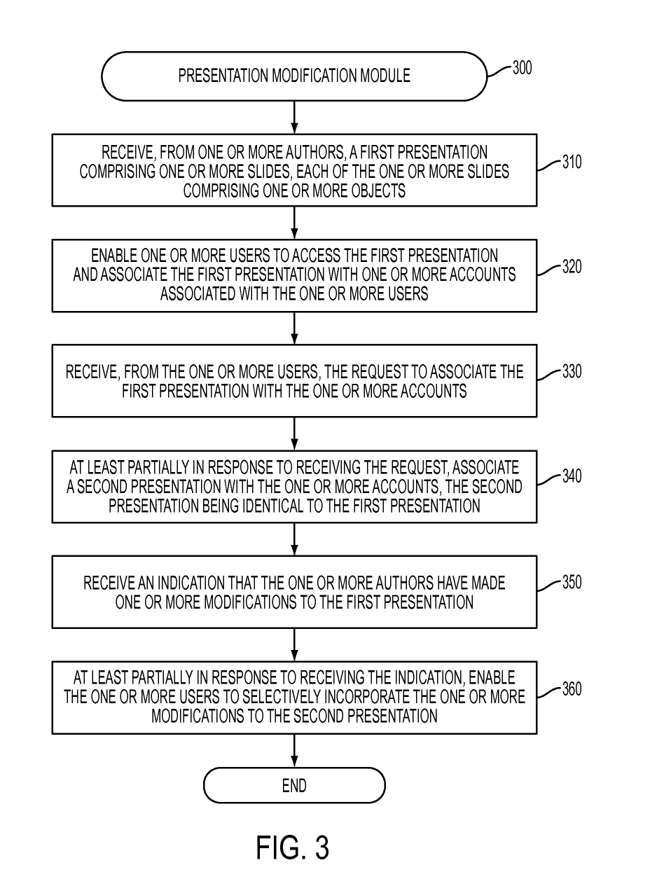

FIG. 3 is a flow chart of operations performed by an exemplary Presentation Modification Module 300. In particular embodiments, the Presentation Modification Module 300 may facilitate the incorporation of modifications to a particular presentation into other versions of the particular presentation.

The system begins, at step 310, by receiving, from one or more authors, a first presentation comprising one or more slides, each of the one or more slides comprising one or more objects. In various embodiments, the system is configured to enable the one or more authors to create the first presentation, for example, by providing the one or more objects for the one or more slides, arranging the one or more objects within the one or more slides, etc. In other embodiments, the system is configured to receive the first presentation, which may, for example, have been created by the one or more authors using any suitable software application.

In particular embodiments, the system is configured to receive the one or more presentations from any suitable one or more authors. For example, in a particular embodiment, the one or more authors may comprise one or more teachers who may, for example, create one or more presentations suitable for teaching or conveying information relating to a particular topic, subject, etc. In other embodiments, the one or more authors may include any suitable person associated with a particular company, who may, for example, be responsible for conveying information related to the particular company or to a particular function, product, etc. of the particular company. In various embodiments, the system is configured to receive a presentation created by a single author. In other embodiments, the one or more authors comprise a plurality of authors, who may, for example, collaborate to create a particular presentation.

In various embodiments, the presentation is configured for display to one or more viewers. The system may be configured to display the presentation on any suitable computing device (e.g., a mobile computing device, interactive touch-screen computing device, etc.). In particular embodiments, the one or more slides may comprise one or more objects, which may, for example, include one or more text objects, one or more images, one or more videos, one or more links to a particular website, one or more representations of a particular website, or any other suitable one or more objects. In other embodiments, the one or more slides may be substantially empty (e.g., may contain no objects). In various embodiments, the one or more slides may be individual presentation slides and may include static content (content that may not be edited during a particular presentation) and/or dynamic content (content that may be edited during a particular presentation). Such content may include, for example, one or more of any of the following objects: (1) pictures; (2) pre-recorded videos; (3) streaming live videos (e.g., the content of which may be received from a third party server); (4) live dynamic images of a web site; (5) static images of a web site; (6) drawings; (7) static screen shots; (8) dynamically changing images of the display of one or more computers; (9) text files; (10) audio files that are to be displayed when the slide is displayed in presentation mode; (11) presentation files; (12) working or non-working versions of one or more spreadsheets; or (13) activities that related to one or more of the other slides in the presentation; (14) test questions that cover the subject matter contained in one or more of the slides in the presentation; (15) annotations on one or more of the slides; and (16) any other suitable content. In various embodiments, the subject matter of the slides may be directed to business topics. In other embodiments, the slide presentation may be directed to a school lesson that may be presented to one or more students in a classroom.

The system continues, at step 320, by enabling one or more users to access the first presentation and associate the first presentation with one or more accounts associated with the one or more users. In particular embodiments, the one or more users may comprise one or more presenters (e.g., one or more presenters that may desire to present the presentation, to view the presentation, etc.). The one or more users may, for example, comprise one or more teachers, one or more administrators, one or more business people, or any other suitable one or more users that may desire to give a particular presentation, view a particular presentation, etc.

In various embodiments, the system is configured to enable the one or more users to access the first presentation via a suitable computing device. In other embodiments, the system is configured to enable the one or more users to access the first presentation via a suitable database 70 of one or more presentations (e.g., in an online store where the user may purchase access to the first presentation, in an online library of one or more presentations made available by the one or more authors, or any other suitable point of access). In particular embodiments, the system is configured to enable the one or more users to preview at least a portion of the one or more slides that make up the first presentation.

In particular embodiments, the system is configured to enable the one or more users to request to associate the first presentation with an account associated with the user. In various embodiments, the system is configured to enable the one or more users to request such association via a suitable computing device (e.g. via any suitable input device associated with the computing device), or in any other suitable manner.

Next, at step 330, the system receives, from the one or more users, the request to associate the first presentation with the one or more accounts (e.g., a user requests to subscribe to the presentation). The system may receive the request in response to any suitable indication and/or request from the one or more users (e.g., activation of one or more indicia for requesting association by the one or more users, or any other suitable indication).

The system continues at step 340 by, at least partially in response to receiving the request, associating a second presentation with the one or more accounts, the second presentation being identical to the first presentation. In various embodiments, associating the second presentation with the one or more accounts comprises saving a copy of the second presentation to memory associated with one or more computing devices of the one or more users. In other embodiments, associating the second presentation with the one or more accounts comprises saving a copy of the second presentation to one or more servers (e.g., remote servers such as the one or more third party servers 50 in FIG. 1) from which the system enables the one or more users to access the second presentation (e.g. from any suitable computing device). In particular embodiments, the second presentation is a copy of the first presentation. In other embodiments, the second presentation is a second version of the first presentation. In still other embodiments, the second presentation is the first presentation.

In various embodiments, the second presentation comprises the same one or more slides having the same one or more objects as the first presentation. In particular embodiments, the system is configured to enable the one or more users to modify the second presentation (e.g., to modify one or more of the one or more slides or one or more objects). In particular embodiments the system is configured to not modify the first presentation in response to modification, by the one or more users, of the second presentation. In such embodiments, the systems may be configured to maintain one or more copies (e.g., stored on one or more suitable servers or in another suitable location) of both the first presentation (e.g., the presentation in its original form) and the second presentation (e.g., which may include a modified version of the first presentation). In particular embodiments the system may store one or more modified presentations as one or more versions of the original presentation (e.g., the first presentation).

Continuing at step 350, the system receives an indication that the one or more authors have made one or more modifications to the first presentation. The systems may be configured to receive the indication, for example, in response to modification of the first presentation by the one or more authors, such as modification to one or more of the one or more slides or the one or more objects. In various embodiments, the system is configured to enable the one or more authors to make one or more modifications to the first presentation substantially dynamically (e.g., while the one or more authors are presenting the presentation). In other embodiments, the system is configured to receive the indication in any other suitable manner. In various embodiments, the one or more modifications may include, for example, an insertion of one or more new slides, a deletion of one or more slides, a reordering of the one or more slides, an addition of one or more objects to the one or more slides, a deletion of one or more objects from one or more slides, a modification of one or more objects of one or more slides, or any other suitable modification. In particular embodiments, the modification of the one or more objects may include a rotation, resizing, movement, rearrangement, color change, cropping, editing of any text content, replacement of any image, or any other suitable modification.

In particular embodiments, the system is further configured to receive, from the one or more authors, an indication of which of the one or more modifications the one or more authors would like to provide to the one or more users who have associate the presentation to their account (e.g., subscribed to the presentation). For example, the one or more authors may indicate that all of the one or more modifications that the one or more authors made to the first presentation should be provided to the one or more users except an addition of a particular slide. In such embodiments, the system is configured to enable the one or more authors to modify the first presentation without providing at least some of the one or more modifications to the one or more users who subscribed to the presentation.

In particular embodiments, the system is configured to enable the one or more authors to provide one or more explanations for the one or more modifications. The system may be further configured to provide the one or more explanations to the one or more users. In various embodiments, this may enable the one or more users to consider the one or more explanations when deciding whether to incorporate the one or more modifications into their version of the presentation.

The system then, at step 360, at least partially in response to receiving the indication at step 350, enables the one or more users to selectively incorporate the one or more modifications into the second presentation. In particular embodiments, the system is configured to notify the one or more users of the modification of the first presentation by the one or more authors (e.g., via a suitable message such as an e-mail or other notifications). The system may then prompt the one or more users to incorporate the one or more modifications into the second presentation. In particular embodiments, the system is configured to substantially automatically update the second presentation to incorporate the one or more modifications to the first presentation.

In various embodiments, the system is configured to display the one or more modifications to the one or more users, for example, to enable the one or more users to decide whether to incorporate the one or more modifications into the second presentation. The system may, for example, display a redlined version of the one or more slides that generally depict the one or more modifications to the one or more slides. In other embodiments, the system is configured to display the first presentation with the one or more modifications adjacent the second presentation (e.g., on a display screen of a computing device), for example, to enable the one or more users to ascertain the one or more modifications to the first presentation (e.g., by visually comparing the first presentation with the one or more modifications to the second presentation). In particular embodiments, the system is configured to display only the one or more slides of the first presentation that have one or more modifications. In particular embodiments, this may enable the one or more users to incorporate the one or more modifications more easily by avoiding review of any unmodified one or more slides.

In particular embodiments, the system is configured to enable the one or more users to incorporate the one or more modifications by either accepting all of the one or more modifications or rejecting all of the one or more modifications. For example, the system may enable the one or more users to review the one or more modifications as discussed immediately above. The one or more users may then elect whether to incorporate the one or more modifications or not, and indicate to the system whether the one or more users wish to incorporate the one or more modifications. In response to the indication that the one or more users wish to incorporate the one or more modifications into the second presentation, the system, in such embodiments, may update the second presentation to include each of the one or more modifications to the first presentation.

In a particular embodiment, the system is configured to enable the one or more users to selectively incorporate the one or more modifications to the second presentation on a slide by slide basis. For example, the system may enable the one or more users to accept or reject an addition of a new slide, a deletion of the one or more slides, and/or a modification of a particular one of the one or more slides. In such embodiments, the system may be configured to cycle through each of the one or more slides, for example, to enable the one or more users to incorporate the one or more modifications for each of the one or more slides (and/or for one or more new slides) individually.

In various embodiments, the system is configured to enable the one or more users to incorporate the one or more modifications on an object by object basis. In particular embodiments, the system is configured to enable the one or more users to selectively accept or reject each of the one or more modifications to the one or more objects, which may include, for example, deletion of the one or more objects, addition of one or more new objects, or one or more modifications to one or more of the one or more objects. In various embodiments, the system is configured to cycle though the one or more modifications to the one or more objects in order to enable the one or more users to accept or reject each particular one or the one or more modifications.

In various embodiments, the system is configured to enable the user to provide the system with one or more preferences for incorporating the one or more modifications (e.g., a preference to incorporate the one or more modifications automatically, on a slide by slide basis, on an object by object basis, etc.). In a particular embodiment, the system is configured to associate the one or more preferences with the one or more accounts associated with the one or more users. In other embodiments, the system is configured to prompt the one or more users for a preference in response to receiving the indication that the one or more authors have made one or more modifications to the first presentation.

In particular embodiments, incorporating the one or more modifications into the second presentation comprises modifying the second presentation to include the one or more modifications. In particular embodiments, incorporating the one or more modifications further includes saving, to memory, a copy of the modified second presentation. In various embodiments, the system is configured to store the modified second presentation on one or more remote servers from which the one or more users may access the modified second presentation (e.g., via a suitable computing device). In other embodiments, the system is configured to store the modified second presentation in any other suitable location to enable the one or more users to access the modified second presentation (e.g., on memory associated with one or more computing devices of the one or more users, etc.).

### Modification of the Second Presentation by the One or More Users

In particular embodiments, the system is configured to enable the one or more users to modify the second presentation. In such embodiments, the system is configured to store a copy of the modified second presentation in a location suitable for providing access to the modified second presentation to the one or more users.

In various embodiments, at least partially in response to one or more modifications of the second presentation by the one or more users, the system is configured to enable the one or more authors to incorporate the one or more modifications into the first presentation. The system may enable the one or more authors to incorporate the one or more modifications in any suitable manner, such as, for example, in any manner described above in relation to enabling the one or more users to incorporate the one or more modifications into the second presentation. In such embodiments, in response to incorporation of the one or more modifications into the first presentation by the one or more authors, the system may be configured to enable the one or more users (e.g., the one or more users that did not modify the second presentation) to incorporate the one or more modifications as well (e.g., the one or more modifications incorporated by the one or more authors, the one or more modifications made to the second presentation, or any other suitable modifications).

In particular embodiments, the system is configured to enable the one or more users to provide one or more explanations of the one or more modifications. In various embodiments, this may enable the one or more authors or one or more other users to consider the one or more explanations when deciding whether to incorporate the one or more modifications into their version of the presentation.

### Version Tracking

In particular embodiments, modification of the first or second presentation by the one or more authors or the one or more users and/or partial acceptance of the one or more author modifications by the one or more users may result in a plurality of different versions of a particular presentation. In a particular example, a first, second and third user may request association of a particular presentation created by an author with their account with the system. The author may then make four modifications to the presentation, that the first, second, and third users may incorporate a different number of modifications into their associated version of the presentation. In this example, there would now be four versions of the presentation—the author created and modified version, and the three user versions that incorporate different modifications by the author from the original presentation. The three users may then create their own modifications to their version of the presentation.

In various embodiments, the system is configured to store each particular version of the presentation, for example, to enable the one or more users to revert to an earlier version of the presentation should the one or more users desire to do so. In other embodiments, the system is configured to enable the one or more users to access, view and/or present any of the plurality of versions of a particular presentation. In other embodiments, the system may be configured to track versions of an individual slide in a presentation. Version information may be stored in a database where each entry contains one or more of (1) an author identification; (2) a modifier identification; (3) identification of the presentation modified; (4) identification of the slide modified; (5) identification of the object modified; (6) date the modification was made; (7) identification of the user that accepted the change; (8) any other suitable information about the presentation, the user making the modification, the modifications made, and the reason for making the modification.

### Exemplary User Experience

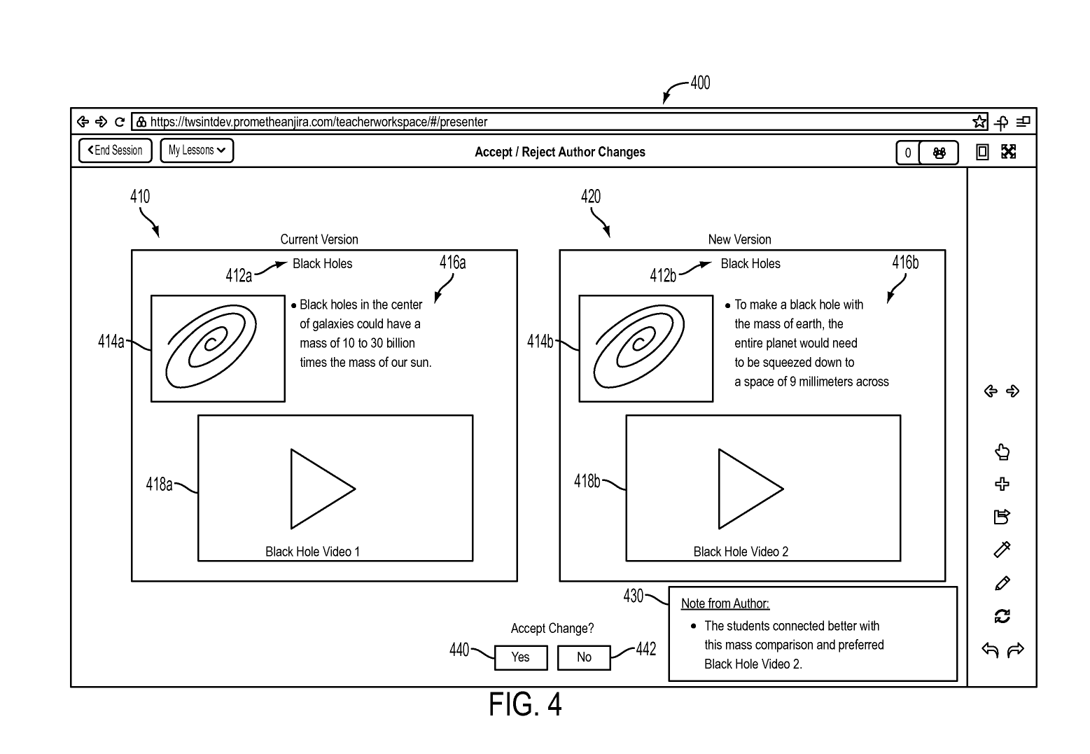

FIG. 4 depicts a screen display showing various features of the system described above according to particular embodiments. An exemplary interface 400 for incorporating one or more author modifications into a presentation is shown in this figure. As may be understood from this figure, the interface 400 displays a current version 410 and a new version 420 of a particular slide of a presentation. The current version 410 and new version 420 comprise a title 412a, 412b; image 414a,414b; text object 416a,416b; and video 418a,418b. As may be understood from this figure, the title 412a, 412b and image 414a,414b are unmodified between the current version 410 and new version 420 of the slide. The text of the text object 416a,416b has been modified in the new version 420 and the video 418a,418b has been changed from one video to another.

As shown in this figure, the interface 400 further comprises an author note 430, which includes an explanation of the change to the currently displayed slide. The interface 400 further comprises indicia for accepting 440 or rejecting 442 the changes. As may be understood from this figure, in response to acceptance of the changes, the system may be configured to replace the current version 410 of the slide with the new version 420 in the user's version of the presentation (e.g., the version associated with eh user's account).

### Conclusion

Many modifications and other embodiments of the invention will come to mind to one skilled in the art to which this invention pertains having the benefit of the teachings presented in the foregoing descriptions and the associated drawings. While examples discussed above cover the use of the invention in the context of a presentation, the invention may be used in any other suitable context, such as within the context of: 1) a webinar; 2) online classes; 3) conferences; 4) advertising/advertising displays; and/or 5) any other suitable system for displaying and/or annotating content. Moreover, the functionality discussed herein may be incorporated into a interactive presentation system that allows a user to create or modify slides in a slide presentation, present the slide presentation to a plurality of users, and push specific information (e.g., electronically editable versions of slides contained in the presentation or of slides that contain information related to the subject matter contained in one or more slides contained in the presentation). Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A computer system comprising:
at least one processor, wherein the computer system is configured for:
a. enabling an author to create a presentation, the presentation comprising at least one slide;
b. associating the presentation with an account of the author;
c. receiving a request from a presenter to associate the presentation with an account of the presenter;
d. at least partially in response to receiving the request to associate the presentation with the account of the presenter, associating a copy of the presentation with the account of the presenter;
e. facilitating at least one modification to the presentation by the author; and
f. at least partially in response to facilitating the at least one modification to the presentation by the author, facilitating including the at least one modification to the copy of the presentation associated with the presenter's account.

2. The computer system of claim 1, wherein the presentation contains one or more materials selected from a group consisting of:
a. a business presentation;
b. a school lesson;
c. a classroom activity;
d. a homework assignment;
e. one or more projects;
f. one or more questions;
g. a test;
h. a simulation
i. one or more worksheets; and
j. one or more games.

3. The computer system of claim 1, wherein facilitating including the at least one modification to the copy of the presentation comprises:
a. transmitting a notification to the presenter indicating the at least one modification has been made by the author; and
b. enabling the presenter to indicate a desire to modify the copy of the presentation to include the at least one modification to the copy of the presentation.

4. The computer system of claim 3, wherein transmitting the notification to the presenter indicating the at least one modifications has been made by the author comprises enabling the author to indicate which of the at least one modifications to include in the notification to the presenter.

5. The computer system of claim 1, wherein the computer system is further configured for:
a. saving the presentation in memory;
b. saving the modified presentation;
c. saving the copy of the presentation in memory; and
d. saving the modified copy of the presentation in memory.

6. The computer system of claim 5, wherein:
a. saving the presentation in memory comprises saving the presentation in memory as a first version of the presentation; and
b. saving the modified presentation in memory comprises saving the modified presentation as a second version of the presentation.

7. The computer system of claim 6, wherein the computer system is further configured for:
a. enabling the presenter to make at least one secondary modification to the copy of the presentation;
b. receiving an explanation, from the presenter, explaining why the at least one secondary modification to the copy of the presentation was made; and
c. at least partially in response to receiving the explanation why the at least one secondary modification was made, transmitting a notification to the author, indicating the at least one secondary modification to the copy of the presentation was made and providing the explanation from the presenter.

8. The computer system of claim 7, wherein the computer system is further configured for:
a. receiving a request from the author to modify the presentation to include the at least one secondary modification; and
b. at least partially in response to receiving the request from the author to modify the presentation, modifying the presentation to include the at least one secondary modification.

9. The computer system of claim 8, wherein the computer system is further configured for saving the presentation that includes the at least one secondary modification in memory as a third version of the presentation.

10. The computer system of claim 9, wherein the computer system is further configured for enabling the author to select a version of the presentation for presenting to at least one presentation viewer.

11. The computer system of claim 6, wherein the computer system is further configured for:
a. receiving a request from a second presenter to associate the presentation with an account of the second presenter;
b. at least partially in response to receiving the request to associate the presentation with the account of the second presenter, associating a second copy of the presentation with the account of the second presenter;
c. saving the second copy of the presentation in memory;
d. enabling the author to make at least one modification to the presentation;
e. at least partially in response to the author making the at least one modification to the presentation, facilitating applying the at least one modification to the second copy of the presentation; and
f. saving the modified second copy of the presentation in memory.

12. The computer system of claim 9, wherein the computer system is further configured for:
a. at least partially in response to receiving the indication of the at least one secondary modification by the presenter, transmitting a notification to the second presenter, indicating the at least one secondary modification to the copy of the presentation;
b. receiving a request from the second presenter to modify the presentation with the at least one secondary modification; and
c. at least partially in response to receiving the request from the second presenter to modify the presentation, modifying the presentation by the at least one secondary modification.

13. A computer-implemented method, comprising:
a. receiving, by a processor, from one or more authors, a first presentation comprising one or more slides, each of the one or more slides comprising one or more objects;
b. receiving, by a processor, from one or more users, a request to associate the first presentation with one or more accounts associated with the one or more users;
c. at least partially in response to receiving the request, associating, by a processor, a second presentation with the one or more accounts, the second presentation being identical to the first presentation;
d. receiving, by a processor, an indication that the one or more authors have made one or more modifications to the first presentation; and
e. at least partially in response to receiving the indication, enabling, by a processor, the one or more users to selectively incorporate the one or more modifications into the second presentation.

14. The computer-implemented method of claim 13, wherein Enabling the one or more users to selectively incorporate the one or more modifications into the second presentation comprises:
a. notifying the one or more users of the one or more modifications;
b. displaying the one or more modifications to the one or more users; and
c. receiving, from the one or more users, and indication of a desire to incorporate each of the one or more modifications.

15. The computer-implemented method of claim 14, wherein receiving the indication of the desire to incorporate each of the one or more modifications comprises receiving an indication selected from a group consisting of:
a. a desire to incorporate the one or more modifications to the entire second presentation;
b. a desire to incorporate the one or more modifications to a particular one of the one or more slides; and
c. a desire to incorporate the one or more modifications to a particular one of the one or more objects.

16. The computer-implemented method of claim 13, wherein said method further comprises:
a. enabling, by a processor, the one or more users to make one or more user modifications to the second presentation;
b. receiving, by a processor, an indication of the one or more user modifications to the second presentation;
c. at least partially in response to the indication:
i. associating a third presentation with the one or more accounts, the third presentation comprising the one or more user modifications; and
ii. enabling, by a processor, the one or more authors to incorporate the one or more user modifications to the first presentation.

17. The computer-implemented method of claim 16, where said method further comprises enabling, by a processor, the one or more users to select among the first presentation, the second presentation, and the third presentation for presenting to at least one presentation viewer.

18. The computer-implemented method of claim 13, wherein said method further comprises:
a. receiving one or more modification comments from the one or more authors, the one or more modification comments being associated with the one or more modifications; and
b. at least partially in response to receiving the one or more modification comments, providing, by a processor, the one or more modification comments to the one or more users.

19. A non-transitory computer-readable medium storing computer-executable instructions for:
a. enabling an author to create a first version of a presentation;
b. receiving a first request from one or more users to associate the first version of the presentation with one or more accounts associated with the one or more users;
c. at least partially in response to receiving the first request, associating the first version of the presentation with the one or more accounts;
d. receiving an indication of one or more modifications to the first version of the presentation by the author;
e. notifying the one or more users of the one or more modifications;
f. receiving, from the one or more users, a second request to associate a second version of the presentation with the one or more accounts, the second version of the presentation comprising one or more of the one or more modifications.

20. The non-transitory computer-readable medium of claim 19, further storing computer executable instructions for:
a. receiving a third request from the one or more users to display the second version of the presentation; and
b. at least partially in response to the third request, displaying the second version of the presentation.

21. The non-transitory computer-readable medium of claim 20, further storing computer executable instructions for:
a. receiving a fourth request from the one or more users to display the first version of the presentation; and
b. at least partially in response to the fourth request, displaying the first version of the presentation.
